(19) United States
(12) Patent Application Publication
(10) Pub. No.: US 2013/0077601 A1
(43) Pub. Date: Mar. 28, 2013

(54) METHOD AND APPARATUS FOR FACILITATING COMPRESSED MODE COMMUNICATIONS

(71) Applicants: Tom Chin, San Diego, CA (US); Guangming Shi, San Diego, CA (US); Kuo-Chun Lee, San Diego, CA (US)

(72) Inventors: Tom Chin, San Diego, CA (US); Guangming Shi, San Diego, CA (US); Kuo-Chun Lee, San Diego, CA (US)

(73) Assignee: QUALCOMM INCORPORATED, San Diego, CA (US)

(21) Appl. No.: 13/379,714

(22) PCT Filed: Apr. 6, 2010
(86) PCT No.: PCT/US10/30147

§ 371 Date: Dec. 21, 2011

Related U.S. Application Data
(60) Provisional application No. 61/243,967, filed on Sep. 18, 2009.

(51) Int. Cl. H04W 72/04

(52) U.S. Cl. CPC H04W 72/0446
USPC 370/335

(57) ABSTRACT

A method and apparatus for facilitating compressed mode communications is provided. The method may comprise receiving a compressed mode indication message, and activating a compressed mode in response to the received compressed mode indication message.

### CROSS-REFERENCE TO RELATED APPLICATION(S)

This application claims the benefit of U.S. Provisional Patent Application No. 61/243,967, entitled “APPARATUS AND METHOD FOR FACILITATING COMPRESSED MODE COMMUNICATIONS”, filed on Sep. 18, 2009, which is expressly incorporated by reference herein in its entirety.

### BACKGROUND

1. Field

Aspects of the present disclosure relate generally to wireless communication systems, and more particularly, to a method and apparatus for facilitating compressed mode communications.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method includes receiving a compressed mode indication message, and activating a compressed mode in response to the received compressed mode indication message.

In an aspect of the disclosure, an apparatus includes means for receiving a compressed mode indication message, and means for activating a compressed mode in response to the received compressed mode indication message.

In an aspect of the disclosure, a computer program product includes a computer-readable medium which includes code for receiving a compressed mode indication message, and code for activating a compressed mode in response to the received compressed mode indication message.

In an aspect of the disclosure, an apparatus includes at least one processor, and a memory coupled to the at least one processor. In such an aspect, the at least one processor may be configured to receive a compressed mode indication message, and activate a compressed mode in response to the received compressed mode indication message.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIG. 4 is a functional block diagram conceptually illustrating example blocks executed to implement the functional characteristics of one aspect of the present disclosure.

FIG. 5 is call-flow diagram of a methodology for facilitating compressed mode communications according to an aspect.

FIG. 6A is an exemplary frame structure with channelization codes depicting data communications according to an aspect.

FIG. 6B is an exemplary frame structure with channelization codes depicting data communications according to another aspect.

FIG. 6C is an exemplary frame structure with channelization codes depicting data communications according to yet another aspect.

FIG. 7 is a block diagram of an exemplary wireless communications device that can facilitate compressed mode communications according to an aspect.

FIG. 8 is a block diagram depicting the architecture of a node B configured to facilitate compressed mode communications according to an aspect.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

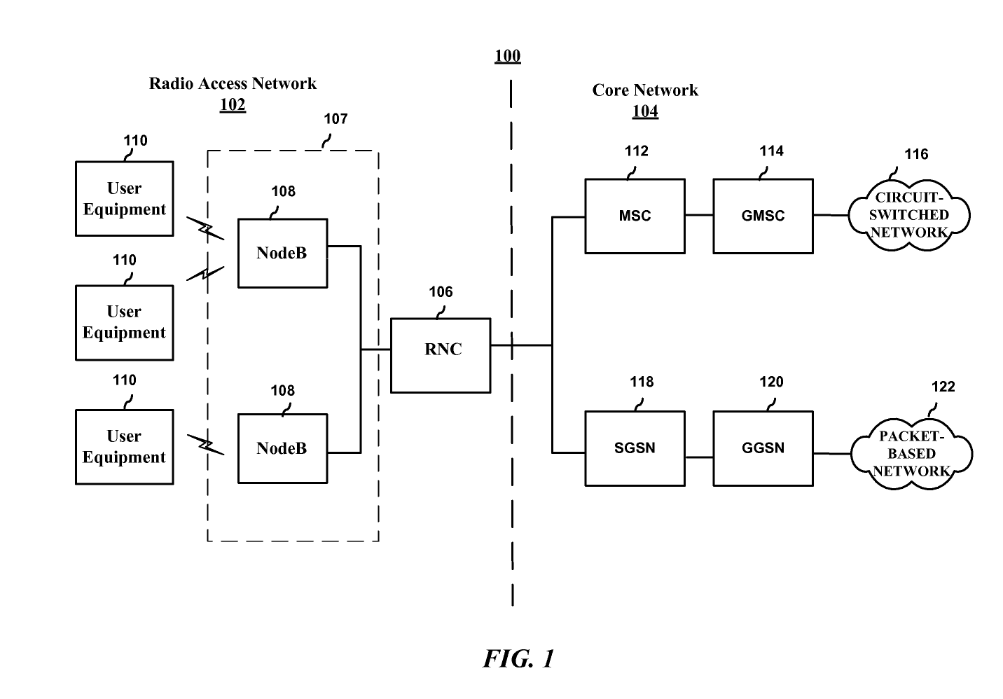

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

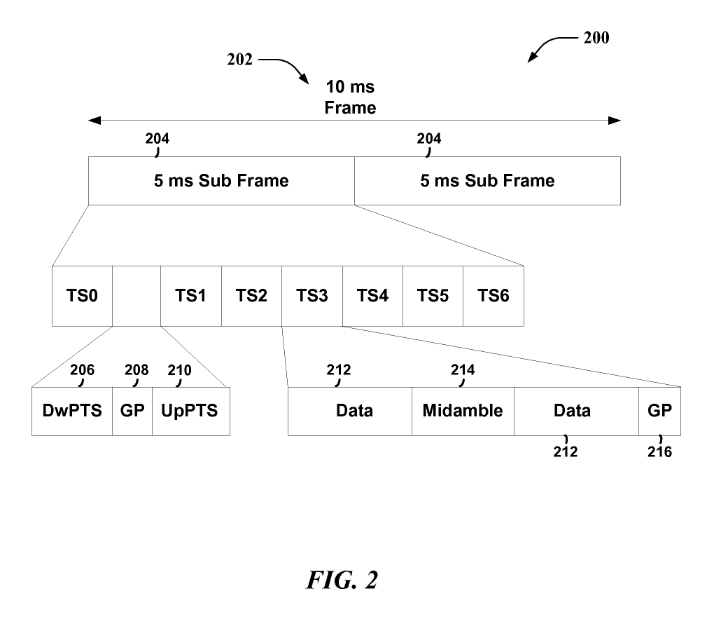

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

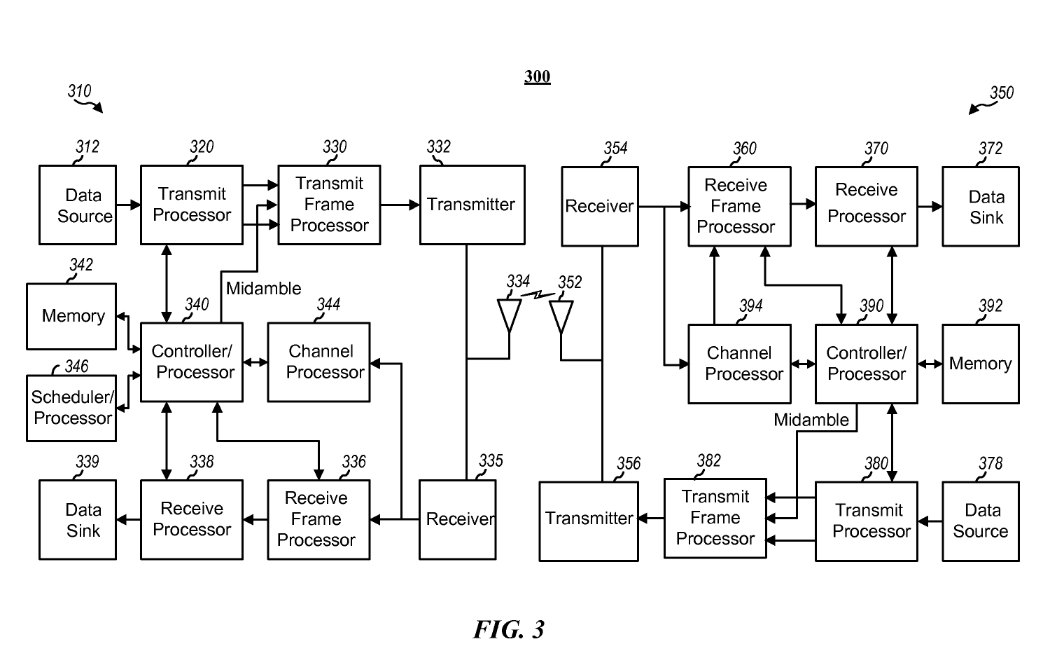

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

In one aspect, controller/processors 340 and 390 may enable communications using a compressed mode. For example, the compressed mode may be used to allow UE 350 to perform pre-synchronization measurements with reduced interface with communications. In such an aspect, processor 390 may be configured to receive a compressed mode indication message, and activate a compressed mode in response to the received compressed mode indication message. Further, such compressed mode communications may be set up using various configuration parameters. In such an aspect, the configuration parameters may include, but are not limited to: an action frame indicating a starting System Frame Number (SFN) with the compressed subframe; an indication of which subframe will be a compressed subframe (e.g. subframe 0 or 1); an UL transmission TS number; a UL transmission channelization codes (e.g. a 16-bit map indicating which channelization codes may be used); a DL transmission TS number; a DL transmission channelization codes (e.g., a 16-bit map indicating which channelization codes can be used); a period (e.g., the number of frames between communication of compressed subframes), etc. For example, the following configuration parameters may be used: action frame=n, compressed subframe=0, UL transmission TS number of transmission=2, UL transmission channelization code bitmap=0b0000001111111100, DL transmission TS number of transmission=3, DL transmission channelization code bitmap: 0b0011111111000000, period=3 frames. In one aspect, using the compressed mode may allow the UE 350 to use one of multi-subframes to transmit or receive data and remaining subframes for measurement. During the non-transmit time slots (TSs), the network may not send or may not receive from the UE. During compressed mode TSs, the network and the UE can send or receive buffered and/or larger amounts of data.

In one configuration, the apparatus 350 for wireless communication includes means for receiving a compressed mode indication message and means for activating a compressed mode in response to the received compressed mode indication message. In one aspect, the aforementioned means may be the processor(s) 370, 390 configured to perform the functions recited by the aforementioned means. In another aspect, the aforementioned means may be a module or any apparatus configured to perform the functions recited by the aforementioned means.

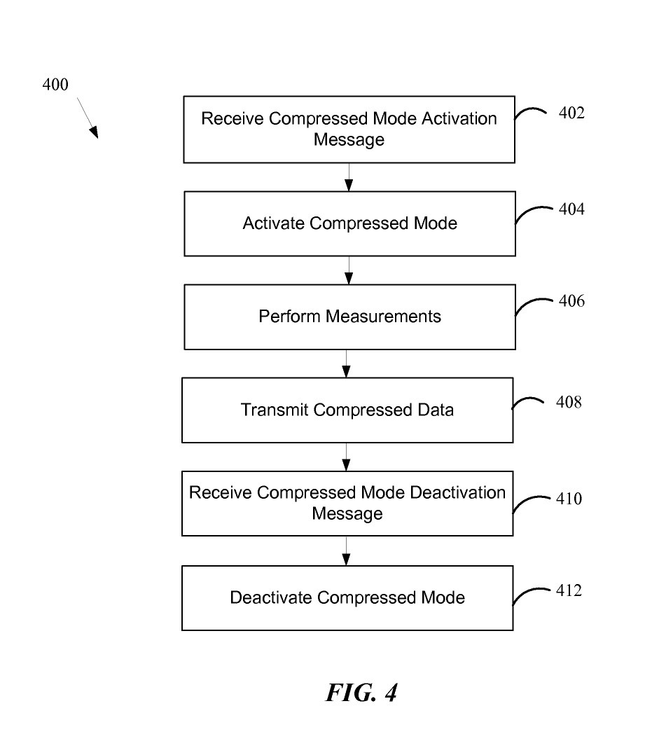

FIG. 4 is a functional block diagram 400 illustrating example blocks executed in conducting wireless communication according to one aspect of the present disclosure. In block 402, a UE may receive a compressed mode activation message. In one aspect, the message may be received using a physical channel reconfiguration complete message. In another aspect, the compressed mode activation message may include compressed mode configuration parameters. In one such aspect, the compressed mode configuration parameters may include: an action frame indicating a starting System Frame Number (SFN) with the compressed subframe; an indication of which subframe will be a compressed subframe (e.g. subframe 0 or 1); an UL transmission TS number; a UL transmission channelization codes (e.g. a 16-bit map indicating which channelization codes may be used); a DL transmission TS number; a DL transmission channelization codes (e.g., a 16-bit map indicating which channelization codes can be used); a period (e.g., the number of frames between communication of compressed subframes), etc. In addition, block 404 the compressed mode may be activated. In one aspect, there may be only one transmit power control (TPC) and synchronization shift (SS) command per compressed subframe that the UE or node B may communicate. In another aspect, the compressed mode may allocate an uplink time slot adjacent to a downlink time slot for communications of compressed data. Furthermore, block 406 measurements may be performed. In one aspect, measurements may include pre-synchronization measurements of inter-frequency values, inter-radio access technology values, etc. In block 408, compressed data may be transmitted. In one aspect, data stored during measurements may be transmitted using compressed mode configurations. In block 410, the UE may receive a compressed mode deactivation message. In one aspect, compressed mode deactivation message may be received using a physical channel reconfiguration message. In block 412, the UE may deactivate the compressed mode and thereafter may revert to normal communications.

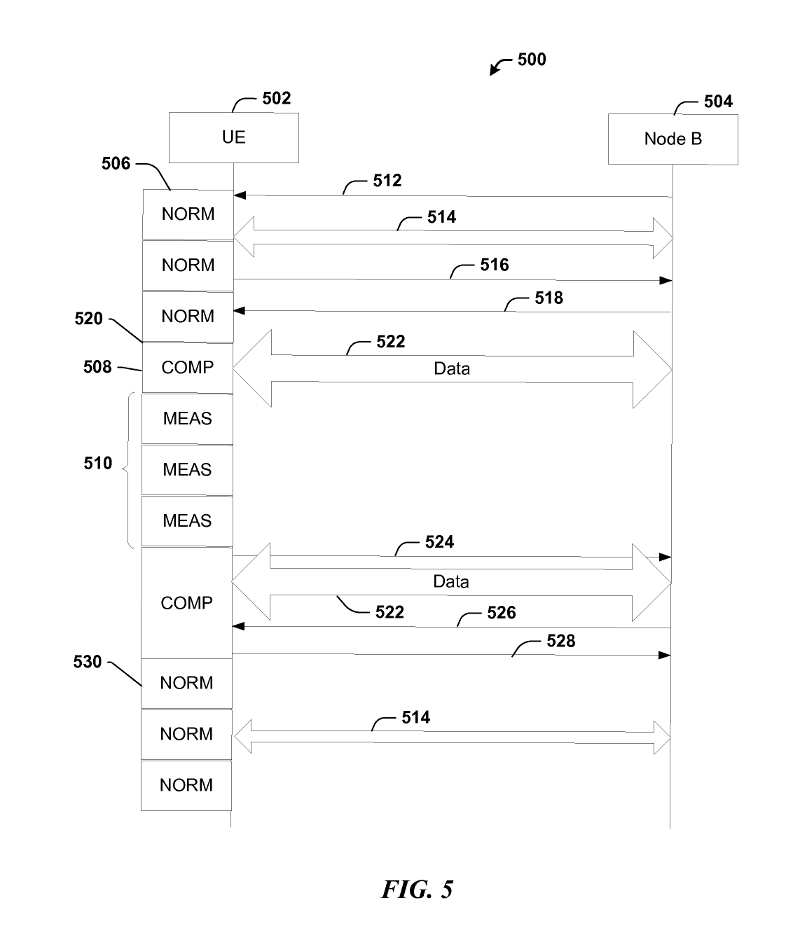

Turning now to FIG. 5, a call flow of an exemplary system 500 for facilitating compressed mode communications is illustrated. Generally, user equipment (UE) 502 and node N 504 may function using various modes, such as but not limited to, normal communication mode 506, compressed communication mode 508 and measurement mode 510.

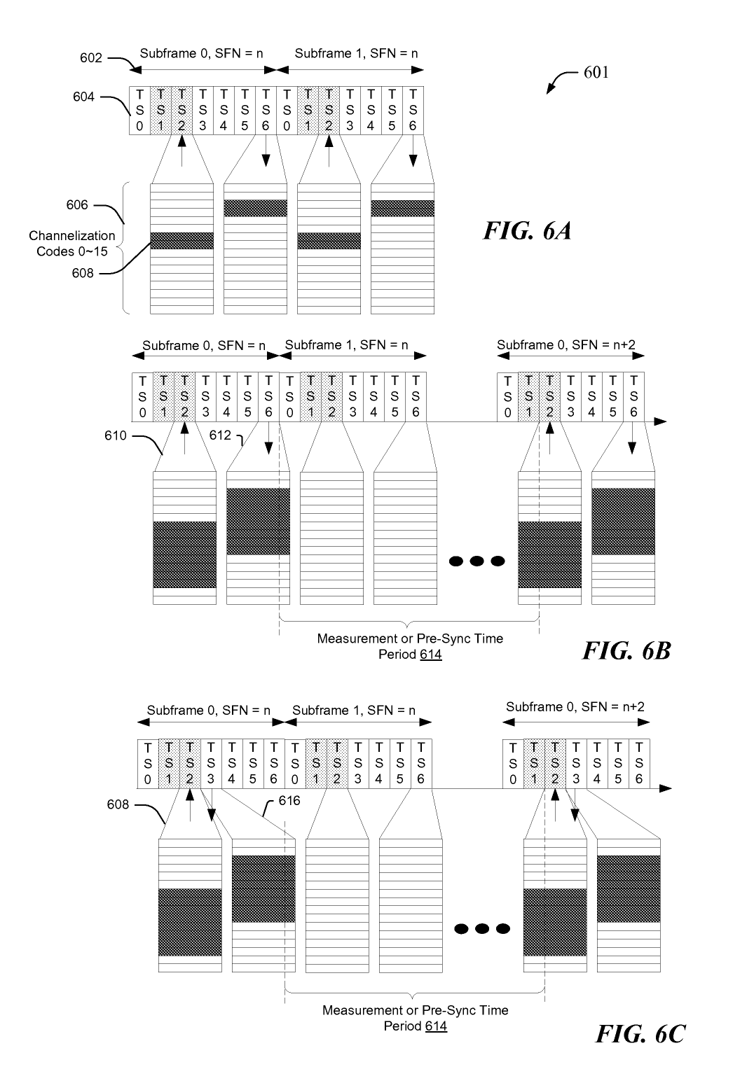

Returning to FIG. 5, at sequence step 512, a message may be received from node B 504 indicating that compressed mode communications may occur. In one aspect of the system 500, a physical channel reconfiguration complete may be used to activate the compressed mode 508 and/or to activate the measurement mode 510. At sequence step 514, normal mode 506 communications may occur. Sequence step 514 may occur at any time during normal mode 506 communications. An example of data being transmitted using normal mode 506 communications is described with reference to FIG. 6A. At sequence step 516, UE 502 may send a message indicating successful completion of compressed mode setup. As noted above, the message may be transmitted using a physical channel reconfiguration complete message, etc.

At sequence step 518, a measurement control message may be transmitted to the UE 502 to indicate that measurement mode 510 may be initiated. In one aspect of the measurement control message, the message may include various configuration parameters for configuring the compressed mode 508. In such an aspect of the message, the parameters may include, but are not limited to: an action frame indicating a starting System Frame Number (SFN) with the compressed subframe; an indication of which subframe will be a compressed subframe (e.g. subframe 0 or 1); an UL transmission TS number; a UL transmission channelization codes (e.g. a 16-bit map indicating which channelization codes may be used); a DL transmission TS number; a DL transmission channelization codes (e.g. a 16-bit map indicating which channelization codes can be used); a period (e.g. the number of frames between communication of compressed subframes), etc. For example, the following parameters may be used: action frame=n, compressed subframe=0, UL transmission TS number of transmission=2, UL transmission channelization code bitmap=0b0000001111111100, DL transmission TS number of transmission=3, DL transmission channelization code bitmap: 0b0011111111000000, period=3 frames.

In one aspect of the call flow 500, at sequence step 520, compressed mode 508 may be initiated and at sequence step 522 communications using the configured compressed mode 508 may occur. In the measurement mode 510 interval, the UE can perform measurement without transmitting or receiving with the serving BS 504. As noted above, measurement mode 510 may also be used to allow the UE 502 to perform other functions such as pre-synchronization, etc. At sequence step 524, a message may be communicated indicating a measurement result report.

Various configurations of compressed mode 508 communications are described with reference to FIGS. 6B and 6C. Additionally, during compressed mode 508 communications, there may be one transmit power control (TPC) and synchronization shift (SS) command used per compressed subframe that the UE or the node B may communicate. In such an aspect, as only one of multiple channelization codes may be carrying TPC and SS information, other transmission code channels can be used for transmission of other data bits instead of the SS and TPC commands, thereby reducing overhead. At sequence step 526, a message may be communicated to indicate the deactivation of compressed mode 508. As noted above, the message may be transmitted using a physical channel reconfiguration complete message. At sequence step 528, confirmation that compressed mode 508 communications will be deactivated are transmitted by the UE 502, and thereafter normal mode 506 communications may recommence at sequence step 530. In one aspect, to maintain consistent operation between the node B 504 and the UE 502, the physical channel reconfiguration message, used to revert to normal mode 506 transmissions, may include an action SFN indicating when normal mode 506 transmissions may recommence.

With reference now to FIGS. 6A, 6B, and 6C, exemplary TD-SCDMA frame structures with channelization codes depicting data communications are illustrated. Generally, in one aspect, a frame 601 may include two subframes 602, where each subframe 602 may include seven (7) time slots 604, where each time slot 604 may include 16 channelization codes 606, and where various channelization codes (e.g. code channels) may be available for communication of data 608.

Turning now to FIG. 6A, a circuit-switched (CS) voice call is depicted in which, two Spreading Factors (SF) of 16 code channels on a downlink (DL) are allocated for the voice call data communications and two SF of 16 code channels on uplink (UL) are allocated for the voice call data communications. Further, in the depicted example, TS2 610 is used for UL communications and TS6 612 is used for DL communications.

Turning now to FIG. 6B, communications using a compressed mode, such as described with reference to FIGS. 3 and 4, during measurements are illustrated. During compressed mode communications, the UE may use one of multi-subframes to transmit or receive and remaining subframes for measurement. During the non-transmit TSs, the node B may not send or will not receive from the UE. During compressed mode TSs, the network and the UE may send and/or receive buffered and/or larger amounts of data. In the depicted exemplary structure, TS0 of Subframe 1 in SFN(n), through TS1 of Subframe 0 in SFN(n+2) can be used as a time period 614 for measurement, pre-synchronization, etc. In one aspect, the measurement period may be approximately 20 milliseconds.

Turning now to FIG. 6C, additional and/or alternative communications using a compressed mode during measurements are illustrated. As is shown in the depicted aspect, the DL and UL may be reconfigured in to be assigned to adjacent TSs to save more time for time-continuous measurement or pre-synchronization (e.g. the UE may reconfigured to receive on TS3 616 instead of TS6 612). In one aspect, such reconfiguration may be performed by using a physical channel reconfiguration procedure.

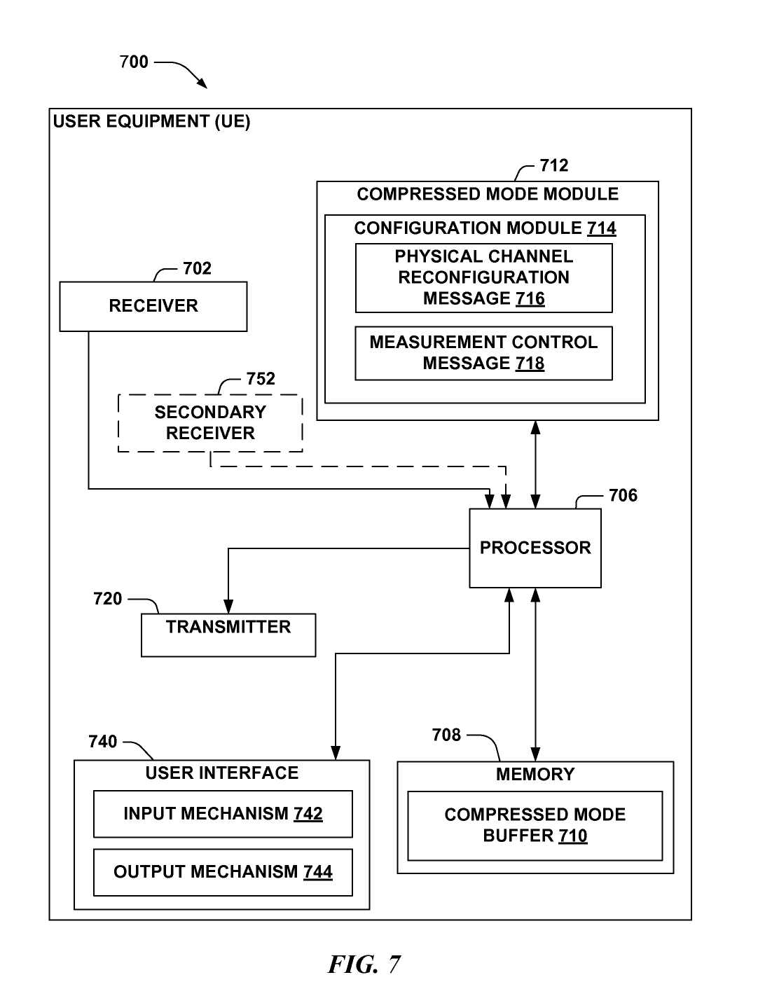

With reference now to FIG. 7, an illustration of a user equipment (UE) 700 (e.g., a client device, wireless communications device (WCD), etc.) that can facilitate compressed mode communications is presented. UE 700 comprises receiver 702 that receives one or more signal from, for instance, one or more receive antennas (not shown), performs typical actions on (e.g., filters, amplifies, downconverts, etc.) the received signal, and digitizes the conditioned signal to obtain samples. Receiver 702 can further comprise an oscillator that can provide a carrier frequency for demodulation of the received signal and a demodulator that can demodulate received symbols and provide them to processor 706 for channel estimation. In one aspect, UE 700 may further comprise secondary receiver 752 and may receive additional channels of information.

Processor 706 can be a processor dedicated to analyzing information received by receiver 702 and/or generating information for transmission by one or more transmitters 720 (for ease of illustration, only one transmitter is shown), a processor that controls one or more components of UE 700, and/or a processor that both analyzes information received by receiver 702 and/or secondary receiver 752, generates information for transmission by transmitter 720 for transmission on one or more transmitting antennas (not shown), and controls one or more components of UE 700.

UE 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.). In one aspect, memory may include content used for compressed mode buffer 710. In such an aspect, content which is not communicated during a measurement time period may be stored in compressed mode buffer 710 for eventual compressed mode communication.

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 708 of the subject systems and methods is intended to comprise, without being limited to, these and any other suitable types of memory.

UE 700 can further comprise compressed mode module 712 that facilitates compressed mode communications from the UE 700. Compressed mode module 712 may include configuration module 714. In such an aspect, configuration module 714 may include physical channel reconfiguration complete message 716 and/or measurement control message 718. Further, in such an aspect, physical channel reconfiguration complete message 716 and/or measurement control message 718 include various configuration parameters such as but not limited to: an action frame indicating a starting System Frame Number (SFN) with the compressed subframe; an indication of which subframe will be a compressed subframe (e.g. subframe 0 or 1); an UL transmission TS number; a UL transmission channelization codes (e.g. a 16-bit map indicating which channelization codes may be used); a DL transmission TS number; a DL transmission channelization codes (e.g. a 16-bit map indicating which channelization codes can be used); a period (e.g. the number of frames between communication of compressed subframes), etc. For example, the following parameters may be used: action frame=n, compressed subframe=0, UL transmission TS number of transmission=2, UL transmission channelization code bitmap=0b0000001111111100, DL transmission TS number of transmission=3, DL transmission channelization code bitmap: 0b0011111111000000, period=3 frames. Moreover, in one aspect of UE 700, processor 706 provides the means for receiving a compressed mode indication message, and means for activating a compressed mode in response to the received compressed mode indication message.

Additionally, UE 700 may include user interface 740. User interface 740 may include input mechanisms 742 for generating inputs into UE 700, and output mechanism 744 for generating information for consumption by the user of UE 700. For example, input mechanism 742 may include a mechanism such as a key or keyboard, a mouse, a touch-screen display, a microphone, etc. Further, for example, output mechanism 744 may include a display, an audio speaker, a haptic feedback mechanism, a Personal Area Network (PAN) transceiver etc. In the illustrated aspects, output mechanism 744 may include a display operable to present content that is in image or video format or an audio speaker to present content that is in an audio format.

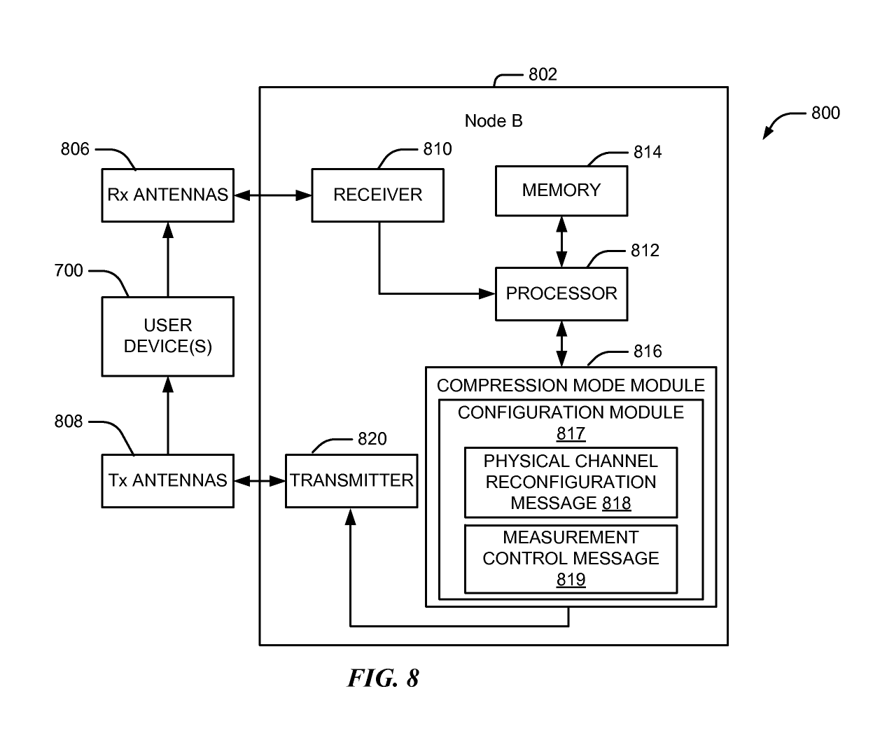

With reference to FIG. 8, an example system 800 that comprises a node B 802 with a receiver 810 that receives signal(s) from one or more user devices 700 through a plurality of receive antennas 806, and a transmitter 820 that transmits to the one or more user devices 700 through a plurality of transmit antennas 808. Receiver 810 can receive information from receive antennas 806. Symbols may be analyzed by a processor 812 that is similar to the processor described above, and which is coupled to a memory 814 that stores information related to data processing. Processor 812 is further coupled to a compressed mode module 816 that facilitates compressed mode communications associated with one or more respective user devices 700.

In one aspect, compressed mode module 816 may include configuration module 817. In such an aspect, configuration module 817 may include physical channel reconfiguration complete message 818 and/or measurement control message 819. Further, in such an aspect, configuration module 817 may include various configuration parameters such as but not limited to: an action frame indicating a starting System Frame Number (SFN) with the compressed subframe; an indication of which subframe will be a compressed subframe (e.g. subframe 0 or 1); an UL transmission TS number; a UL transmission channelization codes (e.g. a 16-bit map indicating which channelization codes may be used); a DL transmission TS number; a DL transmission channelization codes (e.g. a 16-bit map indicating which channelization codes can be used); a period (e.g. the number of frames between communication of compressed subframes), etc. For example, the following parameters may be used: action frame=n, compressed subframe=0, UL transmission TS number of transmission=2, UL transmission channelization code bitmap=0b0000001111111100, DL transmission TS number of transmission=3, DL transmission channelization code bitmap: 0b0011111111000000, period=3 frames.

Further, in one aspect of node B 802, compressed mode module 816 may facilitate the UE 700 using one of multi-subframes to transmit or receive and remaining subframes for measurement. During the non-transmit TSs, node B 802 may not send or will not receive from the UE 700. During compressed mode TSs, the network and the UE can send or receive buffered and/or larger amounts of data.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a time division synchronous code division multiple access (TD-SCDMA) system, comprising:
receiving a compressed mode indication message; and
activating a compressed mode in response to the received compressed mode indication message.

2. The method of claim 1, wherein the compressed mode indication message includes one or more compressed mode configuration parameters.

3. The method of claim 2, wherein a compressed mode configuration parameter of the one or more compressed mode configuration parameters comprises an action frame value indicating a starting system frame number (SFN) for the compressed mode.

4. The method of claim 2, wherein a compressed mode configuration parameter of the one or more compressed mode configuration parameters comprises an uplink transmission time slot value indicating an uplink time slot assignment for using during the compressed mode.

5. The method of claim 2, wherein a compressed mode configuration parameter of the one or more compressed mode configuration parameters comprises an uplink transmission channelization code value indicating an uplink channelization code assignment bitmap for using during the compressed mode.

6. The method of claim 2, wherein a compressed mode configuration parameter of the one or more compressed mode configuration parameters comprises a downlink transmission time slot value indicating a downlink time slot assignment for using during the compressed mode.

7. The method of claim 2, wherein a compressed mode configuration parameter of the one or more compressed mode configuration parameters comprises a downlink transmission channelization code value indicating a downlink channelization code assignment bitmap for using during the compressed mode.

8. The method of claim 2, wherein a compressed mode configuration parameter of the one or more compressed mode configuration parameters comprises a compressed mode period indicating a number of frames between communications during the compressed mode.

9. The method of claim 8, further comprising:
storing data during the compressed mode period; and
transmitting the stored data after the compressed mode period has expired.

10. The method of claim 1, wherein the compressed mode indication message is received using a physical channel reconfiguration complete message.

11. The method of claim 1, wherein the compressed mode comprises using a single transmit power control (TPC) and synchronization shift (SS) command per compressed subframe for communications during the compressed mode.

12. The method of claim 1, wherein the compressed mode comprises allocating an uplink time slot adjacent to a downlink time slot for communications of compressed data during the compressed mode.

13. The method of claim 1, further comprising:
obtaining pre-synchronization measurements during the compressed mode, wherein the measurements include at least one of measuring inter-frequency or inter-radio access technology values; and
transmitting a measurement report including the obtained pre-synchronization measurements.

14. The method of claim 1, further comprising:
receiving a compressed mode deactivation message, wherein the compressed mode deactivation message comprises an action frame value indicating a starting system frame number (SFN) for the deactivating the compressed mode; and
deactivating the compressed mode in response to the received compressed mode deactivation message.

15. An apparatus for wireless communication in a time division synchronous code division multiple access (TD-SCDMA) system, comprising:
means for receiving a compressed mode indication message; and
means for activating a compressed mode in response to the received compressed mode indication message.

16. The apparatus of claim 15, wherein the compressed mode indication message includes one or more compressed mode configuration parameters.

17. The apparatus of claim 16, wherein a compressed mode configuration parameter of the one or more compressed mode configuration parameters of the one or more compressed mode configuration parameters comprises an action frame value indicating a starting system frame number (SFN) for the compressed mode.

18. The apparatus of claim 16, wherein a compressed mode configuration parameter of the one or more compressed mode configuration parameters comprises an uplink transmission time slot value indicating an uplink time slot assignment for using during the compressed mode.

19. The apparatus of claim 16, wherein a compressed mode configuration parameter of the one or more compressed mode configuration parameters comprises an uplink transmission channelization code value indicating an uplink channelization code assignment bitmap for using during the compressed mode.

20. The apparatus of claim 16, wherein a compressed mode configuration parameter of the one or more compressed mode configuration parameters comprises a downlink transmission time slot value indicating a downlink time slot assignment for using during the compressed mode.

21. The apparatus of claim 16, wherein a compressed mode configuration parameter of the one or more compressed mode configuration parameters comprises a downlink transmission channelization code value indicating a downlink channelization code assignment bitmap for using during the compressed mode.

22. The apparatus of claim 16, wherein a compressed mode configuration parameter of the one or more compressed mode configuration parameters comprises a compressed mode period indicating a number of frames between communications during the compressed mode.

23. The apparatus of claim 22, further comprising:
means for storing data during the compressed mode period; and
means for transmitting the stored data after the compressed mode period has expired.

24. The apparatus of claim 15, wherein the compressed mode indication message is received using a physical channel reconfiguration complete message.

25. The apparatus of claim 15, wherein the compressed mode comprises means for using a single transmit power control (TPC) and synchronization shift (SS) command per compressed subframe for communications during the compressed mode.

26. The apparatus of claim 15, wherein the compressed mode comprises means for allocating an uplink time slot adjacent to a downlink time slot for communications of compressed data during the compressed mode.

27. The apparatus of claim 15, further comprising:
means for obtaining pre-synchronization measurements during the compressed mode, wherein the measurements include at least one of measuring inter-frequency or inter-radio access technology values; and
means for transmitting a measurement report including the obtained pre-synchronization measurements.

28. The apparatus of claim 15, further comprising:
means for receiving a compressed mode deactivation message, wherein the compressed mode deactivation message comprises an action frame value indicating a starting system frame number (SFN) for the deactivating the compressed mode; and
means for deactivating the compressed mode in response to the received compressed mode deactivation message.

29. A computer program product, comprising:
a computer-readable medium comprising code for:
receiving a compressed mode indication message; and
activating a compressed mode in response to the received compressed mode indication message.

30. The computer program product of claim 29, wherein the compressed mode indication message includes one or more compressed mode configuration parameters.

31. The computer program product of claim 30, wherein a compressed mode configuration parameter of the one or more compressed mode configuration parameters comprises an action frame value indicating a starting system frame number (SFN) for the compressed mode.

32. The computer program product of claim 30, wherein a compressed mode configuration parameter of the one or more compressed mode configuration parameters comprises an uplink transmission time slot value indicating an uplink time slot assignment for using during the compressed mode.

33. The computer program product of claim 30, wherein a compressed mode configuration parameter of the one or more compressed mode configuration parameters comprises an uplink transmission channelization code value indicating an uplink channelization code assignment bitmap for using during the compressed mode.

34. The computer program product of claim 30, wherein a compressed mode configuration parameter of the one or more compressed mode configuration parameters comprises a downlink transmission time slot value indicating a downlink time slot assignment for using during the compressed mode.

35. The computer program product of claim 30, wherein a compressed mode configuration parameter of the one or more compressed mode configuration parameters comprises a downlink transmission channelization code value indicating a downlink channelization code assignment bitmap for using during the compressed mode.

36. The computer program product of claim 30, wherein a compressed mode configuration parameter of the one or more compressed mode configuration parameters comprises a compressed mode period indicating a number of frames between communications during the compressed mode.

37. The computer program product of claim 36, wherein the computer-readable medium further comprises code for:
storing data during the compressed mode period; and
transmitting the stored data after the compressed mode period has expired.

38. The computer program product of claim 29, wherein the compressed mode indication message is received using a physical channel reconfiguration complete message.

39. The computer program product of claim 29, wherein the computer-readable medium further comprises code for:
using a single transmit power control (TPC) and synchronization shift (SS) command per compressed subframe for communications during the compressed mode.

40. The computer program product of claim 29, wherein the computer-readable medium further comprises code for:
allocating an uplink time slot adjacent to a downlink time slot for communications of compressed data during the compressed mode.

41. The computer program product of claim 29, wherein the computer-readable medium further comprises code for:
obtaining pre-synchronization measurements during the compressed mode, wherein the measurements include at least one of measuring inter-frequency or inter-radio access technology values; and
transmitting a measurement report including the obtained pre-synchronization measurements.

42. The computer program product of claim 29, wherein the computer-readable medium further comprises code for:
receiving a compressed mode deactivation message, wherein the compressed mode deactivation message comprises an action frame value indicating a starting system frame number (SFN) for the deactivating the compressed mode; and
deactivating the compressed mode in response to the received compressed mode deactivation message.

43. An apparatus for wireless communication in a time division synchronous code division multiple access (TD-SCDMA) system, comprising:
at least one processor; and
a memory coupled to the at least one processor,
wherein the at least one processor is configured to:
receive a compressed mode indication message; and
activate a compressed mode in response to the received compressed mode indication message.

44. The apparatus of claim 43, wherein the compressed mode indication message includes one or more compressed mode configuration parameters.

45. The apparatus of claim 44, wherein a compressed mode configuration parameter of the one or more compressed mode configuration parameters comprises an action frame value indicating a starting system frame number (SFN) for the compressed mode.

46. The apparatus of claim 44, wherein a compressed mode configuration parameter of the one or more compressed mode configuration parameters comprises an uplink transmission time slot value indicating an uplink time slot assignment for using during the compressed mode.

47. The apparatus of claim 44, wherein a compressed mode configuration parameter of the one or more compressed mode configuration parameters comprises an uplink transmission channelization code value indicating an uplink channelization code assignment bitmap for using during the compressed mode.

48. The apparatus of claim 44, wherein a compressed mode configuration parameter of the one or more compressed mode configuration parameters comprises a downlink transmission time slot value indicating a downlink time slot assignment for using during the compressed mode.

49. The apparatus of claim 44, wherein a compressed mode configuration parameter of the one or more compressed mode configuration parameters comprises a downlink transmission channelization code value indicating a downlink channelization code assignment bitmap for using during the compressed mode.

50. The apparatus of claim 44, wherein a compressed mode configuration parameter of the one or more compressed mode configuration parameters comprises a compressed mode period indicating a number of frames between communications during the compressed mode.

51. The apparatus of claim 50, wherein the at least one processor is further configured to:
store data during the compressed mode period; and
transmit the stored data after the compressed mode period has expired.

52. The apparatus of claim 43, wherein the compressed mode indication message is received using a physical channel reconfiguration complete message.

53. The apparatus of claim 43, wherein the at least one processor is further configured to:
use a single transmit power control (TPC) and synchronization shift (SS) command per compressed subframe for communications during the compressed mode.

54. The apparatus of claim 43, wherein the at least one processor is further configured to:
allocate an uplink time slot adjacent to a downlink time slot for communications of compressed data during the compressed mode.

55. The apparatus of claim 43, wherein the at least one processor is further configured to:
obtain pre-synchronization measurements during the compressed mode, wherein the measurements include at least one of measuring inter-frequency or inter-radio access technology values; and
transmit a measurement report including the obtained pre-synchronization measurements.

56. The apparatus of claim 43, wherein the at least one processor is further configured to:
receive a compressed mode deactivation message, wherein the compressed mode deactivation message comprises an action frame value indicating a starting system frame number (SFN) for the deactivating the compressed mode; and
deactivate the compressed mode in response to the received compressed mode deactivation message.
